(19) United States
(12) Patent Application Publication
(10) Pub. No.: US 2004/0041919 A1
(43) Pub. Date: Mar. 4, 2004

(54) Digital camera

(76) Inventor: Mutsuhiro Yamanaka, Suita-Shi (JP)

Correspondence Address: SIDLEY AUSTIN BROWN & WOOD LLP, 717 NORTH HARWOOD, SUITE 3400, DALLAS, TX, 75201, US

(21) Appl. No.: 10/329,613

(22) Filed: Dec. 26, 2002

(30) Foreign Application Priority Data
Aug. 27, 2002 (JP) 2002-246652

(51) Int. Cl. H04N 5/228

(52) U.S. Cl. 348/222.1

(57) ABSTRACT

The present invention provides a digital camera capable of performing shading correction more easily. Two images PA1 and PB1 of the same subject are captured while changing the aperture. The shading states of the captured two images PA1 and PB1 are different from each other. A shading correction factor (correction information) is obtained by using the image PB1 in which shading is hardly generated, and the shading in the image PA1 is corrected on the basis of the shading correction factor. It is also possible to correct shading by using two images while changing a focal length or two images captured while changing the presence/absence of electronic flash light.

This application is based on application No. 2002-246652 filed in Japan, the contents of which are hereby incorporated by reference.

### BACKGROUND OF THE INVENTION

1. Field of the Invention

The present invention relates to a digital camera, and more particularly to a technique of correcting shading in a digital camera.

2. Description of the Background Art

In an image captured by a digital camera, due to various causes, “shading” is generated. In order to improve the picture quality, it is therefore requested to remove the influence of such shading from a captured image, that is, to correct the shading.

An example of the conventional technique of performing shading correction is disclosed in Japanese Patent Application Laid-Open No. 2000-13807. In this literature, a technique of obtaining shading correction information by capturing an image while covering a taking lens with a translucent white cap is described.

In the conventional technique, however, capturing of an image of the subject involves operation of manually attaching and detaching the white cap. Consequently, a problem arises such that very troublesome operation is necessary.

### SUMMARY OF THE INVENTION

An object of the present invention is to provide a digital camera capable of more easily performing shading correction.

The present invention is directed to a digital camera.

The one aspect of the present invention provides a digital camera including: an image pickup device for capturing two images whose shading states of the same subject are different from each other by changing an image capturing condition of at least one of an imaging optical system and an illumination system; and a correction information cauculator for obtaining shading correction information for one of the two images on the basis of the two images.

According to the above digital camera, shading correction can be easily made.

Preferably, in the digital camera, the two images are first and second images captured while changing an image capturing condition regarding an aperture of the imaging optical system, and the second image is captured in a state where the aperture is further stopped down as compared with the case of capturing the first image.

According to the structure, shading due to a drop in the brightness of the edge of image field can be easily corrected.

Preferably, in the digital camera, the two images are a first image and a second image captured while changing an image capturing condition regarding a focal length of the imaging optical system, the second image is captured with the focal length shorter than that at the time of capturing the first image, and the correction information calculator obtains the shading correction information by using information of an image region corresponding to a range of the first image in the second image.

According to the structure, shading due to a drop in the brightness of the edge of image field can be easily corrected.

Preferably, in the digital camera, when a difference between a first luminance ratio as a luminance ratio between corresponding regions of the two images with respect to a particular part of the one of images and a second luminance ratio as a luminance ratio between corresponding regions of the two images with respect to a peripheral part of the particular part is smaller than a predetermined degree, the correction information calculator obtains shading correction information of the particular part by using a first rule based on the luminance of the corresponding regions in the two images with respect to the particular part, and when the difference is larger than the predetermined degree, the correction information calculator obtains shading correction information of the particular part by using a second rule different from the first rule.

According to the digital camera, by changing a rule according to the degree of difference between the luminance ratio of corresponding regions of a predetermined part in two images and the luminance ratio of corresponding regions of the periphery of the predetermined part, more appropriate shading correction information can be obtained.

According to another aspect of the present invention, there is provided a digital camera including: an image pickup device for capturing two images of the same subject with and without electronic flash light, respectively; and a correction information calculator for obtaining shading correction information on the image captured with electronic flash light in the two images on the basis of the two images.

According to the structure, shading that subject illuminance becomes nonuniform at the time of emitting electronic flash light due to different subject distances and the like can be easily corrected.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view showing the schematic configuration of appearance of a digital camera;

FIG. 2 is a cross sectional view of the digital camera;

FIG. 3 is a rear view of the digital camera;

FIG. 4 is a schematic block diagram showing the internal configuration of the digital camera;

FIGS. 5A and 5B illustrate shading correction using change of an aperture;

FIGS. 6A and 6B show a state where data level drops due to influence of shading;

FIGS. 7A and 7B show a data level drop state after normalization;

FIGS. 8A and 8B illustrate shading correction using a change in focal length;

FIGS. 9A and 9B show a data level drop state due to influence of shading;

FIG. 10 is a flowchart showing an image capturing operation in a first embodiment;

FIG. 11 is a conceptual view showing an example of a correction table;

FIGS. 12A and 12B show two captured images;

FIG. 13 shows movement of two lens units associated with a change in focal length;

FIGS. 14A and 14B show a state where a conversion lens is not attached and a state where a conversion lens is attached;

FIGS. 15A and 15B illustrate shading correction with/without electronic flash light;

FIG. 16 is a flowchart showing an image capturing operation in a second embodiment; and

FIG. 17 is a flowchart showing processes of a part of FIG. 16.

### DESCRIPTION OF THE PREFERRED EMBODIMENTS

Hereinafter, embodiments of the present invention will be described with reference to the drawings.

A. First Embodiment

A1. Configuration

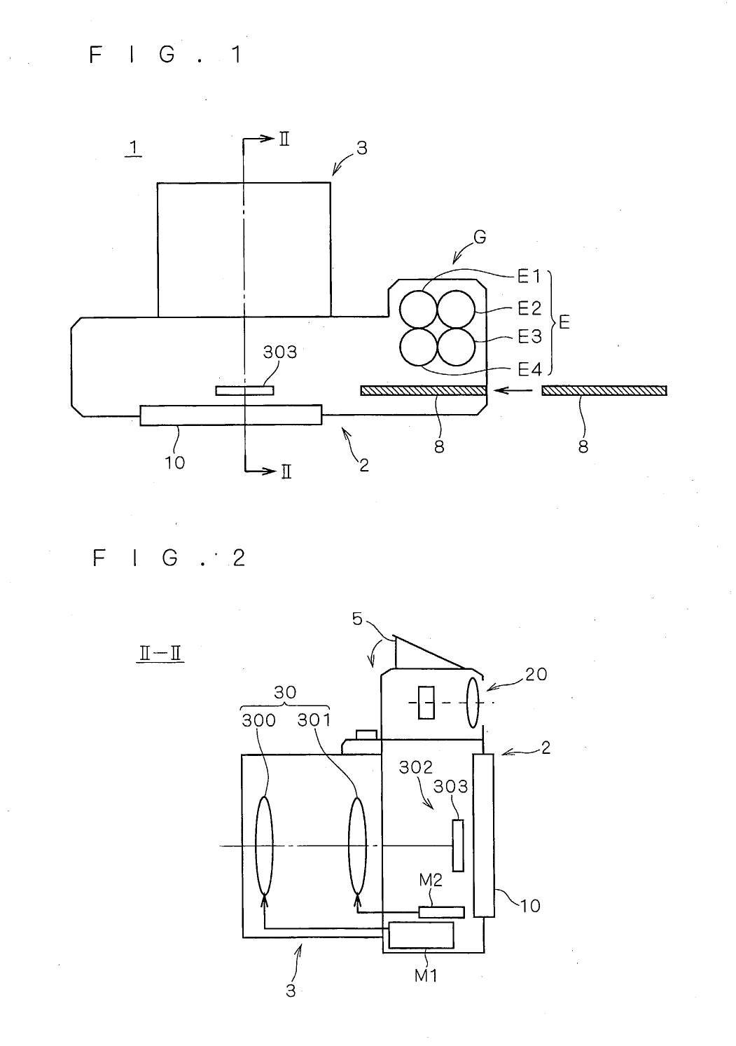

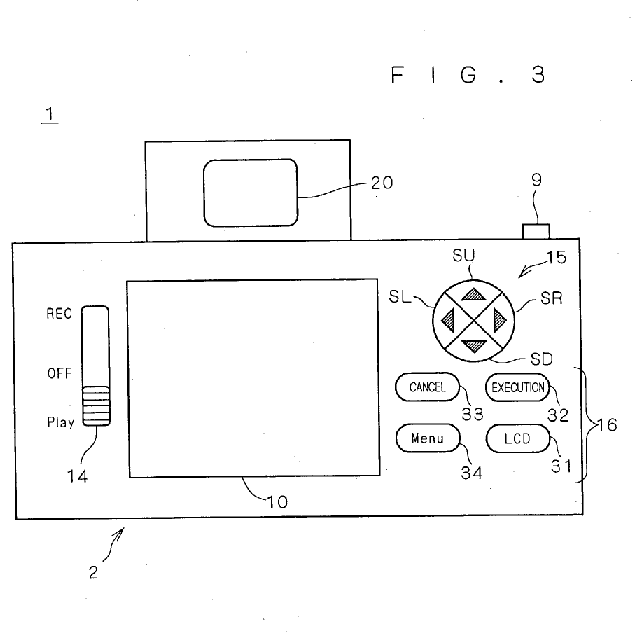

FIGS. 1 to 3 are views each schematically showing the appearance of a digital camera 1 according to a first embodiment of the present invention. FIG. 1 is a plan view of the digital camera 1. FIG. 2 is a cross sectional view taken along line II-II of FIG. 1. FIG. 3 is a rear view of the digital camera 1.

As shown in the figures, the digital camera 1 is constructed by a camera body 2 having an almost rectangular parallelepiped shape and an imaging lens 3 which can be attached/detached to/from the camera body 2. As shown in FIG. 1, a memory card 8 for recording a captured image is freely attached/detached to/from the digital camera 1. The digital camera 1 has, as a driving source, a power supply battery E in which four AA cells E1 to E4 are connected in series.

As shown in FIG. 2, the imaging lens 3 as a zoom lens has a plurality of lens units 30. The figure shows, as the imaging lens 3, two-group zoom system, and the lens units 30 are divided into two lens units 300 and 301. In FIGS. 2 and 3, for simplicity of the drawings, each of the lens units 300 and 301 is shown as a single lens. In practice, each of the lens units 300 and 301 is not limited to a single lens but may be a group of a plurality of lenses.

The camera body 2 has therein a motor M1 for driving the lens unit 300 and a motor M2 for driving the lens unit 301. By moving the lens units 300 and 301 in the optical axis direction independently of each other by driving the motors M1 and M2, the zoom magnification of the imaging lens 3 can be changed. By driving the lens units 300 and 301 by using the motors M1 and M2, the focus state of the imaging lens 3 can be changed, that is, focusing operation can be performed.

A color image pickup device 303 is provided in an appropriate position rearward of the lens units 30 of the imaging lens 3. The color image pickup device 303 takes the form of a single-plate color area sensor in which color filters of R (red), G (green) and B (blue) are adhered in a checker pattern on the surface of pixels of the area sensor formed by a CCD. The color image pickup device (hereinafter, referred to as “CCD”) 303 has, for example, 1920000 pixels of 1600 pixels horizontally by 1200 pixels vertically.

As shown in FIG. 1, in the front face of the camera body 2, a grip part G is provided and a pop-up-type built-in electronic flash 5 is provided in an appropriate position of an upper end point of the camera body 2. As shown in FIG. 3, a shutter start button 9 is provided on the top face of the camera body 2. The shutter start button 9 has the function of detecting a half-depressed state (hereinafter referred to as state S1) used as a trigger for focus adjustment and a full depression state (hereinafter referred to as state S2) used as a trigger of capturing an image for recording and determining the state.

On the other hand, on the rear face of the camera body 2, an electronic view finder (hereinafter, referred to as “EVF”) 20 and a liquid crystal display (hereinafter, referred to as “LCD”) 10 are provided. Different from an optical finder, the EVF 20 and the LCD 10 for performing live view display of image signals from the CCD 303 in an image capturing standby state function as a view finder.

The LCD 10 can display a menu screen for setting an image capturing mode, image capturing conditions, and the like in a recording mode and reproduce and display a captured image which is recorded on the memory card 8 in a reproduction mode.

A power switch 14 is provided in the left part of the rear face of the camera body 2. The power switch 14 also serves as a mode setting switch for switching and setting a recording mode (mode realizing the function of taking a picture) and a reproduction mode (mode of reproducing a recorded image on the LCD 10). Specifically, the power switch 14 is a three-position slide switch. When the contact is set in the center position of “OFF”, the power is turned off. When the contact is set in the upper position of “REC”, the power is turned on and the recording mode is set. When the contact is set in the lower position of “PLAY”, the power is turned on and the reproduction mode is set.

In the right part of the rear face of the camera body 2, a four-way switch 15 is provided. The four-way switch 15 has a circular operation button. By depressing buttons SU, SD, SL and SR in the four ways of up, down, left and right in the operation button, various operations can be performed. For example, the four-way switch 15 functions as a switch for changing an item selected on the menu screen displayed on the LCD 10 and changing a frame to be reproduced which is selected on an index screen. The buttons SR and SL in the right and left ways in a recording mode function as a switch for changing a zoom magnification. Concretely, when the relative position relation of the two lens units 300 and 301 is changed by the driving of the motors M1 and M2, the zoom magnification is changed. More specifically, when the right-way switch SR is depressed, the two lens units 300 and 301 continuously move to the wide angle side. When the left-way switch SL is depressed, the two lens units 300 and 301 continuously move to the telephoto side.

Below the four-way switch 15, a switch group 16 of a cancel switch 33, an execution switch 32, a menu display switch 34, and an LCD display switch 31 are provided. The cancel switch 33 is a switch for canceling an item selected on the menu screen. The execution switch 32 is a switch for determining or executing the item selected on the menu screen. The menu display switch 34 is a switch for displaying a menu screen on the LCD 10 or switching the item of the menu screen. The LCD display switch 31 is a switch for switching on/off of display of the LCD 10.

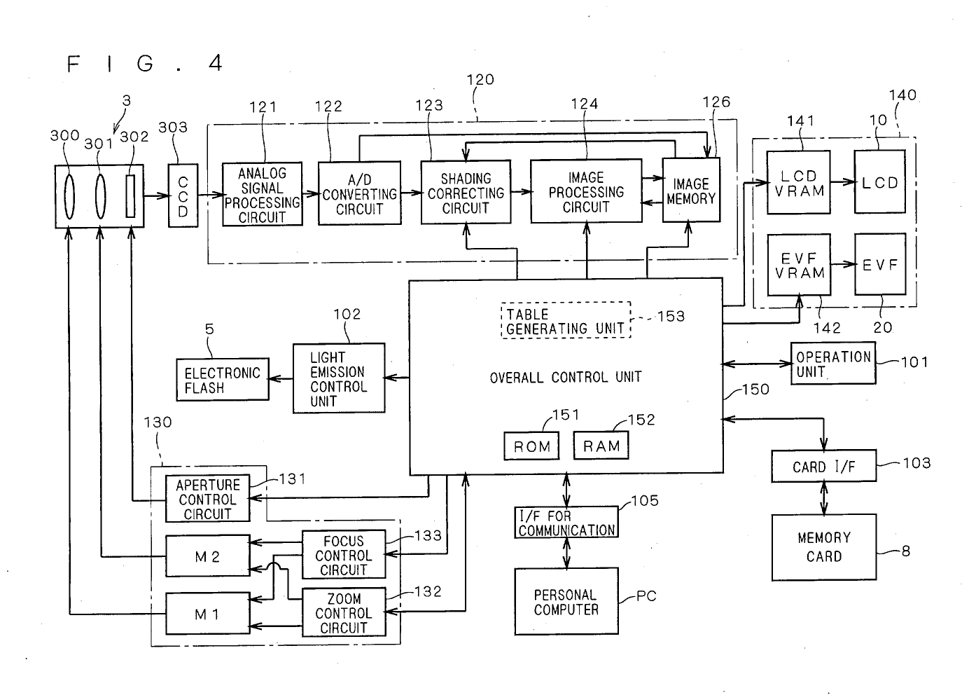

The internal configuration of the digital camera 1 will now be described. FIG. 4 is a schematic block diagram showing the internal configuration of the digital camera 1.

The imaging lens 3 has the lens units 300 and 301 and also an aperture 302 for adjusting the quantity of light passed to the inside. In FIG. 4, for convenience of the diagram, the aperture 302 is disposed on the rear side of the lens unit 301. However, the placement of the aperture 302 is not limited to the above placement. For example, the aperture 302 may be provided in the lens unit 301 (or 300) or provided between the lens units 300 and 301.

The CCD (image pickup device) 303 receives light from the subject (object), which is incident through the imaging lens 3 only for predetermined exposure time and photoelectrically converts the light into an image signal. The CCD 303 outputs the image signal subjected to the photoelectric conversion to a signal processing unit 120. In such a manner, an image of the subject from the imaging lens 3 (imaging optical system) is obtained as an image.

The signal processing unit 120 executes predetermined analog signal processing and digital signal processing on the image signal outputted from the CCD 303. The signal processing on the image signal is performed on every photosensitive signal of each of pixels constructing image data. The signal processing unit 120 has an analog signal processing circuit 121, an A/D converting circuit 122, a shading correcting circuit 123, an image processing circuit 124, and an image memory 126.

The analog signal processing circuit 121 for performing analog signal processing is constructed by mainly a CDS (Correlated Double Sampling) circuit and an AGC (Auto Gain Control) circuit, and performs reduction in sampling noise of a pixel signal outputted from the CCD 303 and adjustment of the signal level. The gain control in the AGC circuit is performed also in the case of compensating an insufficient level of a captured image when proper exposure cannot be obtained from the f-number of the aperture 302 and exposure time of the CCD 303.

The A/D converting circuit 122 converts a pixel signal (image signal) as an analog signal outputted from the analog signal processing circuit 121 to pixel data (image data) as a digital signal. The A/D converting circuit 122 converts a pixel signal received by each pixel into, for example, a digital signal of 10 bits, thereby obtaining pixel data having tone values of 0 to 1023. The pixel data (image data) after conversion is temporarily stored in the image memory 126.

The shading correcting circuit 123 corrects shading caused by the optical system on the A/D converted pixel data. The shading correcting circuit 123 performs a process of multiplying image data converted by the A/D converting circuit 122 by a shading correction coefficient (which will be described later) in a correction table generated by an overall control unit 150, and the like.

The image processing circuit 124 has a WB (White Balance) circuit, a color balance evaluating circuit, a pixel interpolating circuit, a color correction circuit, a γ correction circuit, a color separation circuit, a spatial filter, a resolution converting circuit, a compression/decompression processing circuit, and the like. The WB circuit adjusts white balance of a captured image. The WB circuit converts the level of pixel data of color components of R, G and B by using a result of evaluation on the color balance of a captured image by the color balance evaluating circuit. The pixel interpolating circuit is a circuit of obtaining, by interpolation, two color components which do not exist in reality out of three color components R, G and B in each pixel position in the CCD 303 having a Bayer pattern in which three kinds of color filters of R, G and B are dispersed. The color correcting circuit is a circuit of correcting the spectral sensitivity characteristic of a filter. The γ correcting circuit is a circuit of correcting the γ characteristic of pixel data and corrects the level of each pixel data by using a preset table for γ correction. The color separating circuit is a circuit of converting (R, G, B) signals to (Y, Cr, Cb) signals. The spatial filter is a circuit for performing various filtering processes such as edge emphasis by using a low-pass filter, a high-pass filter and the like. The resolution converting circuit is a circuit of converting the resolution to desired resolution. The compression/decompression processing circuit is a circuit of performing a process of compressing data into data of a predetermined format such as JPEG and a process of decompressing compressed data.

The image memory 126 is a memory for temporarily storing image data. The image memory 126 has a storage capacity capable of storing image data of two or more frames, specifically, for example, a storage capacity of storing image data of (1920000 pixels×2=) 3840000 pixels. Each of the processes in the image processing circuit 124 is performed on image data stored in the image memory 126.

The light emission control unit 102 controls light emission of the electronic flash (illumination light source) 5 on the basis of a light emission control signal received from the overall control unit 150. The light emission control signal includes instruction of preparation for light emission, a light emission timing, and a light emission amount.

A lens control unit 130 controls driving of members of the lens units 300 and 301 and the aperture 302 in the imaging lens 3. The lens control unit 130 includes: an aperture control circuit 131 for controlling the f-number (aperture value) of the aperture 302, a zoom control circuit 132 for changing the magnification of the zoom (in other words, changing the angle of view) by driving the motors M1 and M2, and a focus control circuit 133 for performing focusing control by driving the motors M1 and M2.

The aperture control circuit 131 drives the aperture 302 on the basis of the f-number inputted from the overall control unit 150 and sets the aperture as the f-number. The focus control circuit 133 controls the drive amount of the motors M1 and M2 on the basis of an AF control signal inputted from the overall control unit 150 to set the lens units 300 and 301 to the object distances. The zoom control circuit 132 moves the lens units 300 and 301 by driving the motors M1 and M2 on the basis of a zoom control signal inputted from the overall control unit 150 in accordance with an input by the four-way switch 15, thereby moving the zoom to the wide angle side or the telephoto side.

A display unit 140 displays an image on the LCD 10 and the EVF 20. The display unit 140 has, in addition to the LCD 10 and the EVF 20, an LCD VRAM 141 as a buffer memory of image data to re reproduced and displayed on the LCD 10, and an EVF VRAM 142 as a buffer memory of image data reproduced and displayed on the EVF 20.

In an image capturing standby state, each of pixel data of an image (image for live view) captured every 1/30 (second) by the CCD 303 is subjected to a predetermined signal process by the signal processing unit 120 and, after that, the processed data is temporarily stored in the image memory 126. The data is read by the overall control unit 150 and its data size is adjusted. After that, the resultant data is transferred to the LCD VRAM 141 and the EVF VRAM 142 and displayed as a live view on the LCD 10 and the EVF 20. Consequently, the user can visually recognize an image of the subject. In a reproduction mode, an image read out from the memory card 8 is subjected to a predetermined signal process by the overall control unit 150 and, after that, the processed data is transferred to the LCD VRAM 141 and reproduced and displayed on the LCD 10.

An operation unit 101 is to input operation information of operating members regarding image capturing and reproduction provided for the camera body 2 to the overall control unit 150. The operation information inputted from the operation unit 101 includes operation information of operating members such as the shutter start button 9, power switch 14, four-way switch 15, and switch group 16.

The overall control unit 150 is a microcomputer for performing centralized control on the image capturing function and the reproducing function. To the overall control unit 150, the memory card 8 is connected via a card interface 103 and a personal computer PC is externally connected via an interface 105 for communication.

The overall control unit 150 has: a ROM 151 in which a processing program for performing a number of concrete processes in the image capturing function and the reproducing function and a control program for controlling driving of the members of the digital camera 1 are stored; and a RAM 152 as a work area for performing a number of computing works in accordance with the processing program and the control program. Program data recorded on the memory card 8 as a recording medium can be read via the card interface 103 and stored into the ROM 151. Therefore, the processing and control programs can be installed from the memory card 8 into the digital camera 1. Alternately, the programming and control programs may be installed from the personal computer PC via the interface 105 for communication.

The overall control unit 150 has a table generating unit 153 for generating a table for shading correcting process. The table generating unit 153 is a function unit functionally realized when the processing program or the like is executed by using a microcomputer or the like.

A2. Principle

The basic principle of shading correction in the embodiment will now be described.

In the specification, “shading” denotes a phenomenon in which unevenness of luminance exists in an image captured by an image pickup apparatus (digital camera in this case) as compared with an image of the subject perceived by human's sight. In other words, “shading” denotes a phenomenon that a luminance distribution state in an image captured by an image pickup apparatus is different from that in the case where a human sees the subject not through an image pickup apparatus but directly. “Shading correction” means correction of such shading.

Concretely, the “shading” is classified into some kinds in accordance with, for example, the situation and/or cause. For example, “shading” is a phenomenon including at least the following two kinds of:

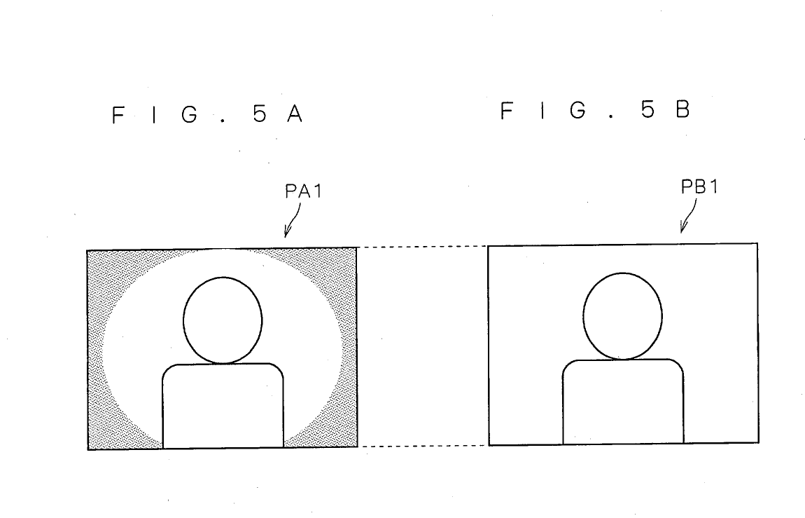

(1) shading P1 (see FIG. 5A and so on) caused by a drop in a brightness of the edge of image field; and

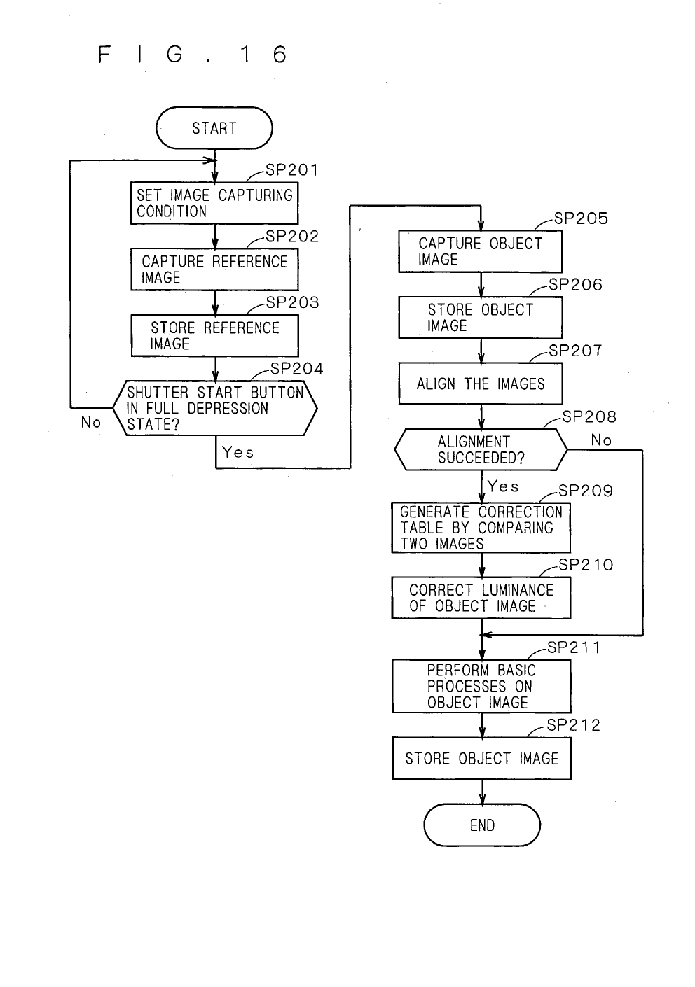

(2) shading P2 that the illuminance of the subject by an illumination light source (such as electronic flash light) becomes nonuniform (see FIG. 15A).

The shading P1 of (1) is generated due to various causes such as “vignetting” and “cos⁴ law”. “Vignetting” (also called “eclipse”) denotes that a ray incident on a peripheral portion of a predetermined focal plane (a pickup device) is interrupted by a frame or the like disposed in front of/behind the aperture. This causes a drop in the ray amount in the edge of an image. The “cos⁴ law” is a law that brightness of the peripheral portion decreases in proportional to cos⁴ of an incident angle with respect to the optical axis of an incident light flux to the peripheral portion. According to such the “cos⁴ law”, the quantity of light of the peripheral portion decreases.

On the other hand, as will be described later, the shading P2 of (2) is caused by insufficient/excessive illuminance of the subject based on variations in the subject distance of subjects in an image.

In the first embodiment, a technique of correcting the shading P1 of (1) out of the two kinds of shading will be described. A technique of correcting the shading P2 of (2) will be described in a second embodiment.

FIGS. 5A and 5B illustrate the principle of correcting the shading P1 of (1). Based on the principle described below, a component caused by “vignetting” in the shading P1 can be corrected.

FIG. 5A illustrates a situation in which shading is generated in an image PA1 captured by the digital camera 1. In the image PA1, the luminance level of pixel data decreases with distance from the center point of the image to the periphery, and the luminance value in the peripheral portion is lower than that in the center portion. FIG. 5A shows, for simplicity of the drawing, a state where the peripheral portion is darker than the center portion. In reality, the luminance level of a pixel gradually decreases with distance from the center.

To correct shading in the image PA1, an image PB (PB1, PB2 or the like) is used. Since the image PA1 is an image as an object (target) to be captured, it is also called an “object image (or target image)”. Since the images PB1 and PB2 are images referred to for correction of shading in the object image (target image), they are also called “reference images”. The object images (target images) are also generically called an image PA. The reference images are generically called an image PB.

In the first embodiment, at the time of capturing the object image PA1, another image PB is captured at a different timing. The image PA1 is an image read from the CCD 303 in response to an image capturing trigger signal which is generated in response to depression of the shutter start button 9 to the full depression state S2. As the image PB, an image captured immediately after (for example, after 1/10 second) the image PA1 is captured.

As described above, the image PA (object image) and the image PB (reference image) are captured at time points which are extremely close to each other with respect to time. In other words, the images PA and PB are images captured successively. Therefore, while suppressing an influence of movement of the subject, the sameness of the subject can be assured in an almost perfect state. The higher the sameness of the subject is, the more it is preferable. However, it is not required that the subjects are perfectly the same. For example, as the sameness of the subject, it is sufficient that the positions of the two images PA and PB can be excellently matched with each other.

Although the images PA1 and PB1 are common to each other with respect to the same subject, the states of shading are different from each other for the reason that the two images PA1 and PB1 are captured while the image capturing condition of the aperture among the image capturing conditions of the optical system is changed. More specifically, the image PB1 is captured in a state where the aperture at the time of capturing an image is stopped down more than the image PA1.

In the following, first, the case of correcting the shading P1 by using the image PB1 captured while changing the “aperture” will be described.

Generally, in shading, when the aperture is stopped down (that is, when the f-number is relatively large), the degree of drop of the quantity of incident light in the peripheral portion decreases. By using this characteristic, shading caused by vignetting is corrected.

For example, the image PB1 is captured with the minimum aperture (the largest f-number). It can prevent occurrence of shading (or reduce the degree of shading) in the image PB1 even if shading is generated in the image PA1 captured with a relatively large aperture (in other words, with the small f-number). More specifically, at the time of capturing the image PA1 with f=2.8, the image PB1 may be captured with f=8.0 (the minimum aperture). FIG. 5B shows a state where shading hardly generates.

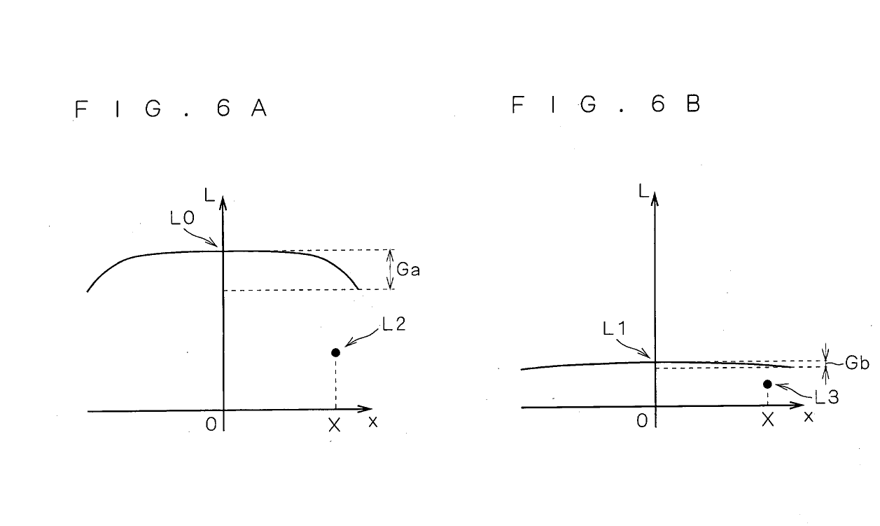

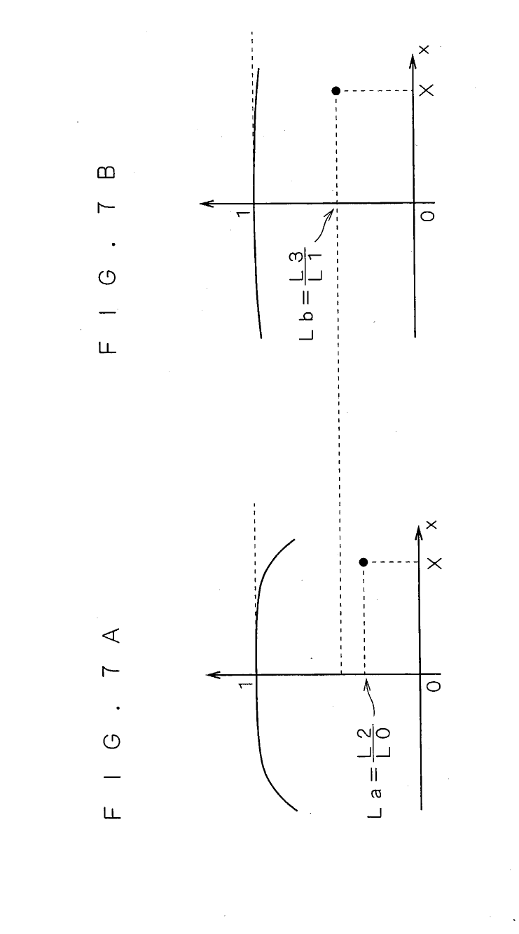

FIG. 6A shows a graph of a luminance distribution when the same f-number as that in the case of capturing the image PA1 is employed. FIG. 6B shows a graph of a luminance distribution when the same f-number as that in the case of capturing the image PB1 is employed. FIGS. 6A and 6B do not directly show the luminance distributions of the images PA1 and PB1 but are on assumption that all of pixels constructing an image receive incident light from the subject of the same luminance. Specifically, the graphs show the reduction ratio of the level of pixel data due to influence of shading in each pixel position. In each of the graphs, the horizontal axis indicates the position x in the horizontal direction and the vertical axis indicates the luminance value L of each pixel in each horizontal position.

As understood from comparison of the graphs of FIGS. 6A and 6B, since the aperture at the time of capturing the image PB1 is further stopped down from the aperture at the time of capturing the image PA1, the average luminance value (see FIG. 6B) of the image PB1 is smaller than that (see FIG. 6A) of the image PA1. On the other hand, the difference Gb between the luminance of the peripheral portion and the luminance in the center portion in FIG. 6B is smaller than the difference Ga between the luminance of the peripheral portion and the luminance of the center portion in FIG. 6A (Gb<Ga). That is, the influence of shading in the image PB1 is reduced as compared with the image PA1.

A correction factor (coefficient) h1 of a pixel apart from the center by a distance X is computed. The correction factor h1 is expressed by the following equation 1 by using luminance values L0 and L1 of pixels in the center position in the images PA1 and PB1, respectively, and luminance values L2 and L3 of pixels apart from the center by the distance X in the images PA1 and PA1, respectively.

$$h 1 = \frac{\frac{L 3}{L 1}}{\frac{L 2}{L 0}} = \frac{L b}{L a} \qquad Equation 1$$

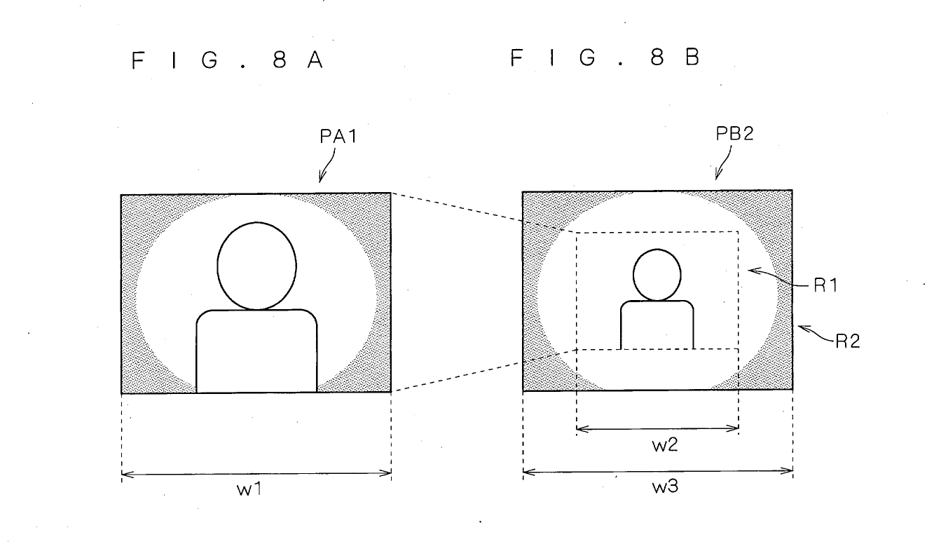

Equation 1 will be described with reference to FIGS. 7A and 7B. In order to make the luminance level of the relatively dark image PB1 and that of the relatively bright image PA1 coincide with each other, by normalizing the values, the luminance value of the pixel in the center position of each of the images PA1 and PB1 becomes “1”. The luminance values of pixels apart from the center by the predetermined distance X in the images PA1 and PB1 are a value La=(L2/L0) and a value Lb=(L3/L1). FIGS. 7A and 7B show the values obtained after normalization.

For example, when it is assumed that the values L0, L1, L2, and L3 are 100, 20, 40, and 10, respectively, La=40/100=0.4 and Lb=10/20=0.5.

It is considered that the pixel value of the image PA1 decreases by (La/Lb) times (for example, 0.4/0.5=0.8 time) due to the influence of shading. Therefore, when the inverse, that is, the value (Lb/La) is determined as a value of the correction factor h1 and the original pixel value L2 is multiplied with the correction factor h1 (for example, 0.5/0.4=1.25), the influence of shading can be corrected.

In such a manner, the shading P1 can be corrected by using the image PB1 captured while changing the “aperture”.

The case of correcting the shading P1 by using another image PB2 captured while changing “focal length” in the zoom lens will now be described. The two images PA (PA1) and PB (PB2) are captured after the image capturing condition regarding the focal length out of the image capturing conditions of the optical system is changed. More specifically, the image (reference image) PB2 is obtained on the wider angle side than that at the time of capturing the image PA1. By using the image PB2, a drop in the marginal light in the image PA1 is corrected.

Since the image PB2 is an image captured with a larger angle of field than the image PA1, a range wider than the image PA1 is captured in the image PB2. There is a characteristic such that the influence of shading is conspicuous in the peripheral portion but is little (ideally, does not exist) in the center portion. By using the characteristic, shading caused by vignetting is corrected.

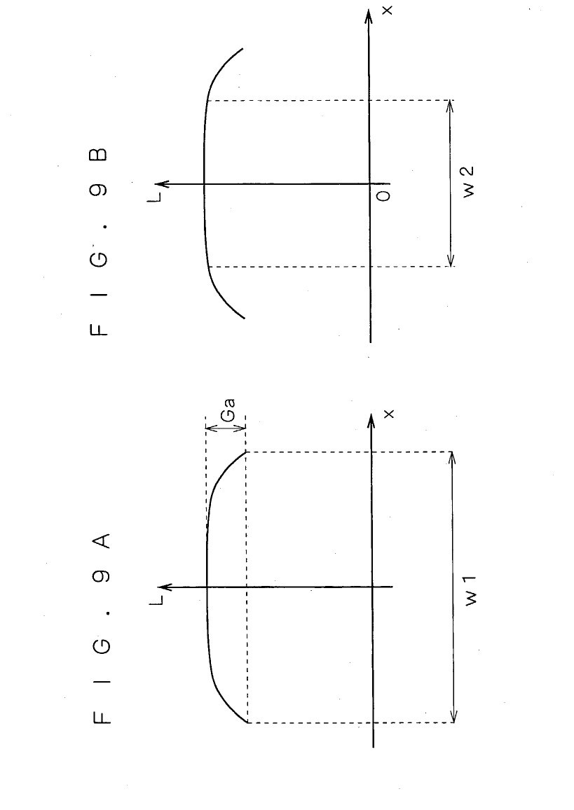

FIGS. 8A and 8B illustrate the images PA1 and PB2, respectively. Also in the images PA1 and PB2, a state that a drop in brightness of the edge of image field is caused by shading due to vignetting is shown.

In the images PA1 and PB2, the states of shading regarding a portion corresponding to the same subject are different from each other. Concretely, in the image PB2, although the influence of shading is large in the peripheral portion, in the center portion, the influence of shading is small and the luminance distribution relatively close to an ideal state can be obtained. Therefore, the influence of shading is relatively small in a region R1 in the image PB2. As shown in FIG. 8B, the image region (rectangular region on the inner side of the diagram) R1 in the image PB2 (the rectangular region R2 on the outer side of the diagram) is a region corresponding to a range captured of the image PA1.

As described above, since the image PB2 is captured so that the captured range of the image PA1 in the image PB2 lies within the center portion of the image PB2, a drop in the brightness which generates in the peripheral portion does not occur in the center portion of the image PB2. In other words, the maximum image height of the image PA1 corresponds to the image height of the image PB2 without vignetting.

In other words, it is preferable that the image PB2 be captured in a state such that the captured range R1 corresponding to the image PA1 lies within the range where no drop in the brightness is generated in the image PB2. For example, the image PB2 may be captured with a focal length of 80% of the focal length which is employed at the time of capturing the image PA1.

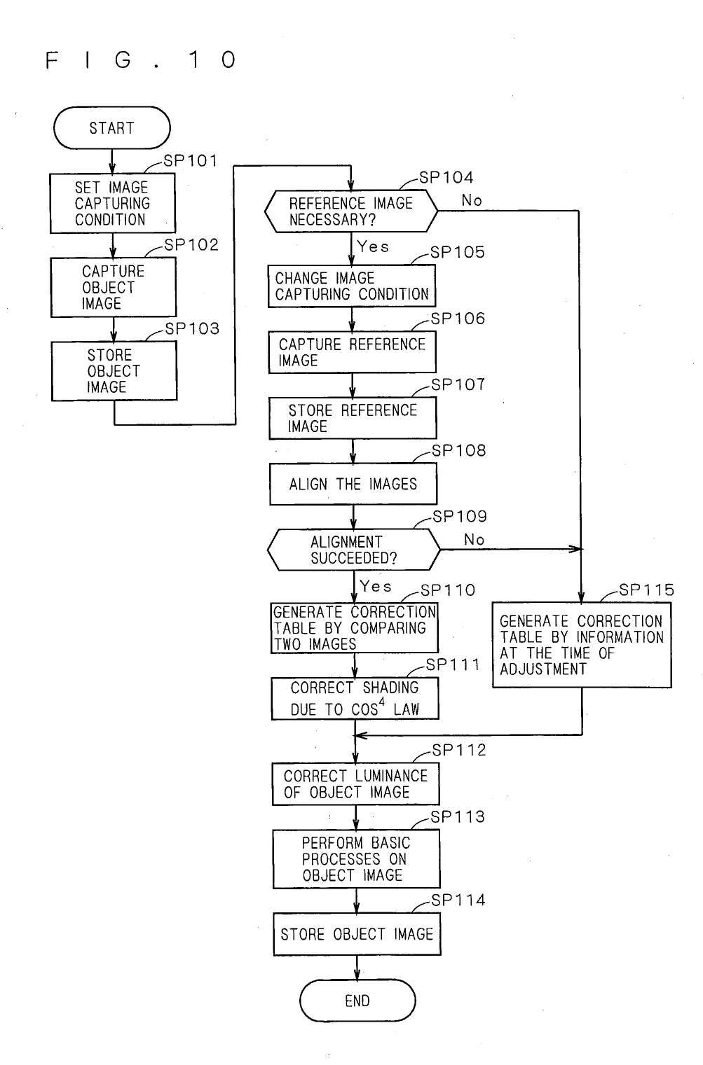

FIGS. 9A and 9B show the influence of shading in the images PA1 and PB2, respectively. The horizontal axis indicates the position x in the horizontal direction, and the vertical axis indicates the luminance value L of each pixel in each horizontal position.

As shown in FIGS. 8A and 8B and FIGS. 9A and 9B, a range w1 of capturing the image PA1 corresponds to a range w2 in the image PB2. In the image PB2, the capturing range w2 is within a range where no drop in the brightness is generated. In other words, in the range w2 in the image PB2, the influence of shading is reduced more than in the range w1 in the image PA1.

Consequently, it is sufficient to make correction by applying the idea similar to the above by using the luminance values in corresponding positions in the images PA1 and PB2.

Concretely, the correction factor h1 of a pixel Pa apart from the center by the distance X in the image PA1 is expressed by the following equation 2 using the luminance values L0 and L1 of the pixels in the center position in the images PA1 and PB2, respectively, the luminance value L12 of the pixel Pa apart from the center by the distance X in the image PA1, and the luminance value L13 of a pixel Pb corresponding to the pixel Pa in the image PB2.

$$h 1 = \frac{\frac{L 1 \; 3}{L 1}}{\frac{L 12}{L 0}} \qquad Equation 2$$

By multiplying the original pixel value L12 by the correction factor h1, the influence of shading can be corrected.

As described above, on the basis of two images captured while changing the aperture and/or focal length, the component caused by “vignetting” in the shading P1 can be corrected.

The component caused by the cos⁴ law in the shading P1 depends on the geometric characteristic of a lens. Thus, a correction value h2 similar to the above can be preliminarily computed on the basis of the theoretical value at a designing stage of the lens. Therefore, it is sufficient to further multiply the result value, which is obtained by multiplying the original pixel value of the target image PA1 by the correction value h1 for the component caused by the vignetting, by the correction value h2 for correcting the component caused by the cos⁴ law. In such a manner, more excellent shading correction can be made.

A3. Operation

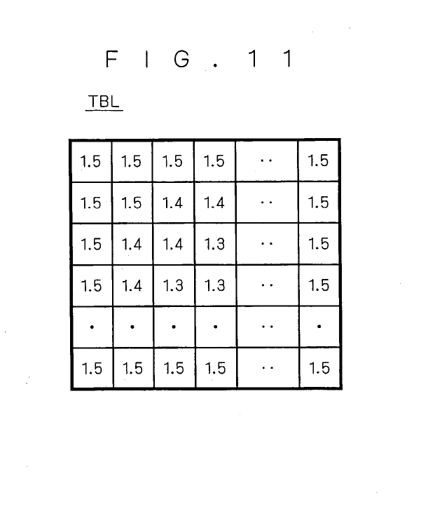

Referring now to FIG. 10, the detailed operation in the first embodiment will now be described. FIG. 10 is a flowchart showing an example of the image capturing operation.

As shown in FIG. 10, first, in steps SP101 to SP103, the object image PA is obtained.

Concretely, when the image capturing conditions such as aperture and zoom are set (step SP101) and the shutter start button 9 is depressed to the full depression state S2, the object image PA (PA1) of the subject is captured (step SP102) and stored in the image memory 126 (step SP103).

More specifically, the image of the subject received by the photosensitive elements of the CCD 303 is photoelectrically converted and, after that, the resultant is outputted as an image signal to the analog signal processing circuit 121. The analog signal processing circuit 121 performs a predetermined process on the image signal and outputs the processed signal to the A/D converting circuit 122. The A/D converting circuit 122 converts the analog image signal outputted from the CCD 303 to a digital image signal and outputs the digital image signal to the image memory 126. The converted digital image signal is temporarily stored as image data of the image PA in the image memory 126. In such a manner, the image PA is stored into the image memory 126.

The object image PA is immediately obtained in response to depression of the shutter start button 9 without waiting for acquisition of the reference image PB, so that occurrence of a deviation between the time point of depression of the shutter start button 9 and the time point of acquisition of the image PA can be avoided.

At this time point, on the image PA, basic image processes such as shading correcting process and white balance correcting process are not performed yet.

In step SP104, either the shading correction in the above-described method (hereinafter, also referred to as method H1) or shading correction of a normal method (hereinafter, also referred to as method H0) is determined to be performed.

The shading correction of the method H0 is performed by, for example, multiplying each pixel by a predetermined correction factor prestored in the correction table in the ROM 151. In the correction table in the ROM 151, it is sufficient to determine a correction factor for correcting shading caused by the “cos⁴ law” or the like on the basis of a theoretical value in designing or the like.

In step SP104, which one of the methods H0 and H1 is employed is determined according to the image capturing conditions of the image PA.

More specifically, with respect to the image capturing conditions of the image PA, (i) in the case where the aperture is larger than a predetermined degree (when the f-number is smaller than a predetermined value), and (ii) in the case where the focal length is larger than a predetermined value, the program advances to step SP105 and the shading correction of the method H1 is performed. In the other cases, the program advances to step SP115 and the shading of the method H0 is performed.

When it is determined that capturing of the reference image PB (for example, PB1 or PB2) is necessary, the image capturing conditions are changed in step SP105. The changing operation is performed under control of the overall control unit 150 via the aperture control circuit 131 and/or zoom control circuit 132.

Concretely, when the condition (i) that the aperture is larger than the predetermined degree is satisfied (the f-number is smaller than the predetermined value), the overall control unit 150 sets the aperture to the minimum aperture amount. When the condition (ii) that the focal length is larger than the predetermined value is satisfied, the focal length is set to a value of 80% of the value used at the time of capturing the image PA. When both of the conditions are satisfied, that is, when the aperture is larger than the predetermined degree and the focal length is larger than the predetermined value, the aperture is set to the minimum aperture, and the focal length is set to the value of 80% of the value used at the time of capturing the image PA. The present invention is not limited to the case but only one of the image capturing conditions may be changed.

After that, the reference image PB is obtained (step SP106) and stored in the image memory 126 (step SP107). At this time point, in a manner similar to the image PA, on the image PB as well, basic image processes such as shading correcting process and white balance correcting process are not performed yet.

In step SP108, the images PA and PB are aligned. For the alignment, various techniques such as pattern matching can be used. By the alignment, the same parts in the subject are associated with each other in the images PA and PB.

In step SP109, a branching operation is performed according to a result of the alignment.

In the embodiment, since the images PA and PB are captured in very short time, the association of the subject is relatively excellently performed. However, in the case such that the motion of the subject is very fast, the sameness of the subject in the images PA and PB may deteriorate terribly, and alignment fails. In such a case, in place of performing the shading correction of the method H1, the program advances to step SP115 where the shading correction of the method H0 is performed.

On the other hand, when the alignment is succeeded, the program advances to step SP110 and the shading correction of the method H1 is performed.

In step SP110, as described above, a correction table is generated by using the two images PA and PB.

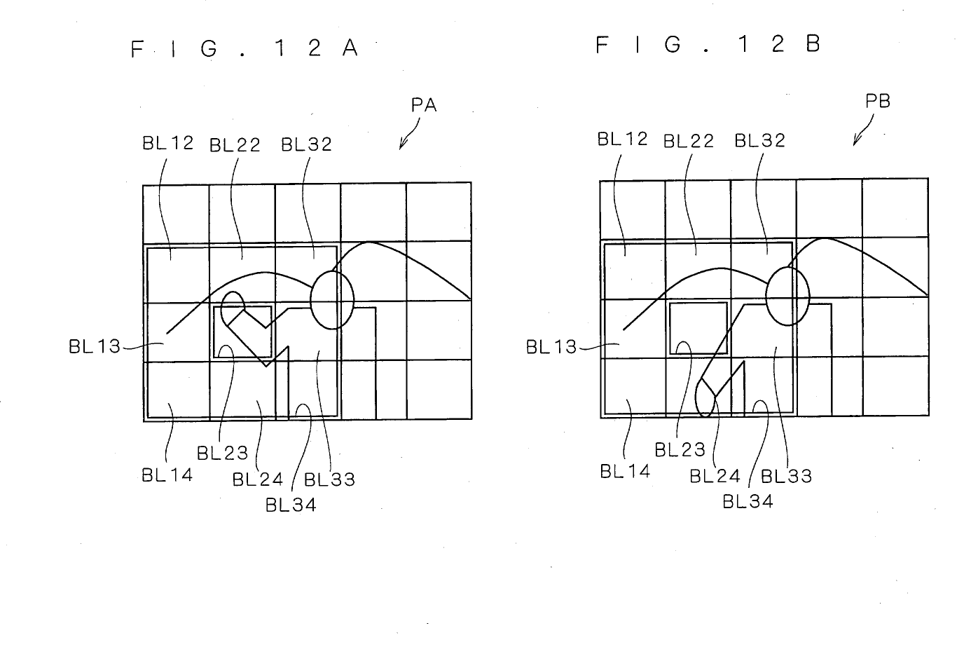

FIG. 11 shows an example of a correction table TBL generated in step SP110.

In such a correction table, 1920000 correction factors may be provided so as to correspond to 1920000 pixels (=1600 pixels×1200 pixels) of the CCD 303 in a one-to-one manner. In this case, however, the data size becomes enormous.

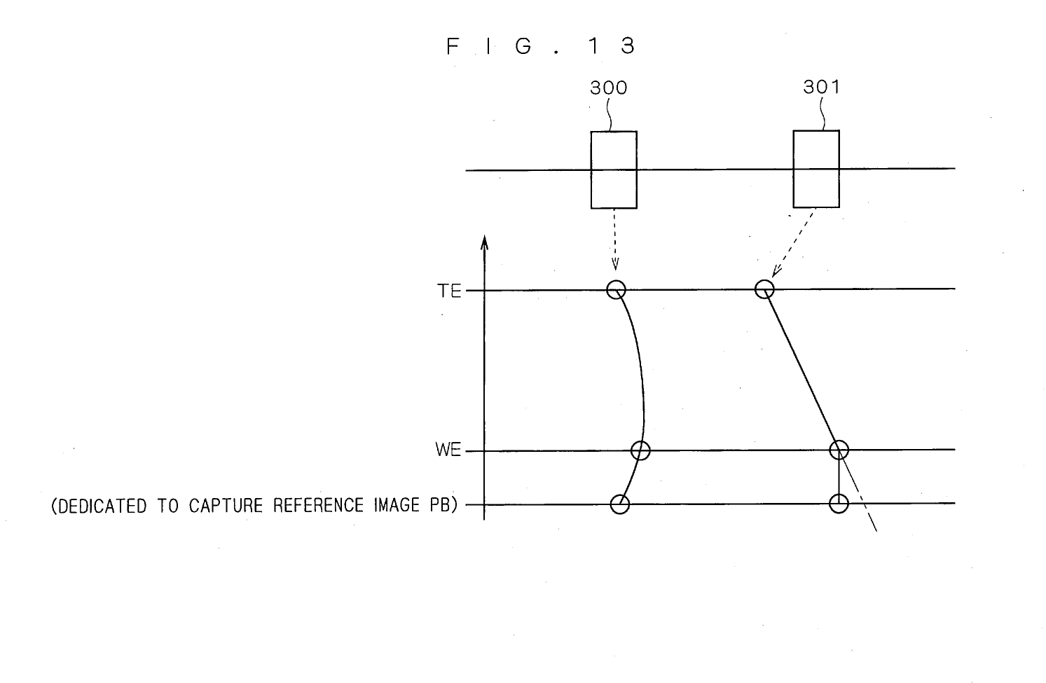

Consequently, in the correction table TBL adopted in the embodiment, the image PA is divided into a plurality of blocks each having a predetermined pixel size and the correction factor is determined for each block. Concretely, one piece of correction data is set in unit of a block having a predetermined size (for example, 4 pixels×4 pixels) and correction is performed for every block of pixels. It enables the data size of the correction table TBL to be reduced. Alternately, the image may be divided into blocks each having a larger size. For example, as shown in FIGS. 12A and 12B, the size of each block is set as (320 pixels×300 pixels), and the image PA may be divided into 5×4=20 blocks BLij (i=1 to 5, j=1 to 4). To improve the correction precision, however, the size of unit block is preferably smaller.

In the following step SP111, considering also the correction factor h2 for lessening the influence of shading caused by the cos⁴ law, data in the correction table TBL is corrected. Concretely, by multiplying the correction factor h1 stored in the correction table TBL by the correction factor h2 according to each position, the correction factor is updated.

On the basis of the correction table in which the updated correction factor is stored, shading correction is performed on the image PA (step SP112). To be specific, by multiplying the pixel value of each of pixels in the image PA by the correction factor (h1×h2) corresponding to the pixel stored in the correction table, shading correction is performed. Such a correction computing process is performed by the shading correcting circuit 123 under control of the overall control unit 150. When overflow generates in the multiplying process, the level of the pixel data may be set to the maximum value (that is, 1023).

After that, in step SP113, predetermined image processes (such as WB process, pixel interpolating process, color correcting process, and γ correcting process) are further performed on the image PA subjected to the shading correction and, after that, the processed image PA is temporarily stored in the image memory 126. Further, the image PA stored in the image memory 126 is transferred to the memory card 8 and stored in the memory card 8.

In such a manner, the operation of capturing the image PA with the shading correction is performed.

As described above, by using the two images PA and PB of different shading states, the influence of shading in the image PA finally captured can be lessened. In addition, it is unnecessary to perform the operation of manually attaching/detaching a white cap unlike the conventional technique. According to the first embodiment, therefore, the shading correction can be performed with the simple operation.

According to the first embodiment, since the operator can correct shading in the image PA by the series of image capturing operations of adjusting the image capturing conditions and depressing the shutter start button 9, especially, ease of operability is high.

In the case where the sameness of the subject in the two images PA and PB is partially lost, at the time of computing the correction factor in the part by using Equation 1 or the like, it is preferable not to use the luminance of the part in the images as it is.

For example, in step SP110 (in FIG. 10), as shown in FIGS. 12A and 12B, a case where the image PA is divided into (5×4=) 20 blocks BLij (i=1 to 5, j=1 to 4) and the correction factor of each block is computed is assumed. In this case, a person as the subject moves his/her arm immediately after image capturing, so that the images PA and PB have parts (such as block BL23 in almost the center of the diagram) different from each other. Whether each block is such a different part or not can be determined as follows. Concretely, when the luminance ratio between two images regarding a certain block (for example, the block BL23) differs from the luminance ratio between two images regarding peripheral blocks of the certain block (for example, eight blocks around the block BL23) in a greater amount than a predetermined degree, the block may be determined as a different part.

Since the corresponding relation between the images is not accurate in such a different part, the shading correction value based on the luminance ratio between two images of the part becomes inaccurate.

For such a different part, therefore, the luminance average value including the peripheral part of the certain block is used as the luminance value of the part, and the shading correction value of the block is computed. For example, the shading correction factor h1 for the block BL23 is not obtained by using only the luminance of the block BL23 in each of the images PA and PB but may be computed as follows. Concretely, first, an average luminance value in nine blocks (the block BL23 and its peripheral eight blocks BL12, BL22, BL32, BL13, BL33, BL14, BL24, and BL34) in the image PA and that in corresponding nine blocks in the image PB are obtained. The average luminance values are respectively regarded as luminance values of the images PA and PB with respect to the block BL23 and it is sufficient to compute the correction factor h1 on the basis of Equation 1 or the like.

As described above, when the difference between a luminance ratio between the corresponding regions in the two images PA and PB with respect to the certain part (block BL23) in the image PA and another luminance ratio between the corresponding regions of the two images PA and PB with respect to the peripheral parts (for example, eight blocks around the certain block) is smaller than a predetermined degree, by using a principle rule RL1, to be specific, a rule based on the luminance of the corresponding regions in the images PA and PB with respect to the “certain part” (for example, the rule based on the luminance of the block BL23 in the image PA and the luminance of the block BL23 in the image PB), shading correction information of the certain part is obtained. On the other hand, when the difference of the luminance ratios is larger than the predetermined degree, by using an exceptional rule RL2, to be specific, a rule based on not only the luminance of the certain part but also the luminance of the “peripheral parts” of the certain part, shading correction information of the certain part is obtained.

By the above operation, at the time of obtaining the shading correction information of the different part, by substantially changing (more specifically enlarging) the block as unit of calculating the luminance, the influence of the partial difference can be lessened. Therefore, as compared with the case of obtaining the shading correction factor based on only the corresponding relation of every block size, the correction precision by the shading correction factor can be improved.

A4. Modification of First Embodiment

Although the case of setting the aperture to the minimum aperture which can be used for the normal image capturing operation at the time of capturing the image PB1 has been described as an example, the present invention is not limited to the case. Concretely, an image may be captured with the aperture which is further smaller than the minimum aperture (for example, f-number=8.0) which can be used for the normal image capturing operation. For example, an image captured with a small aperture which is not used for normal image capturing operation due to image deterioration (with an f-number which is relatively large value) such as the aperture of the f-number of about 32 (f=32.0) can be used as an image PB1.

Generally, when the aperture of the aperture stop becomes smaller than the predetermined degree, deterioration in resolution caused by diffraction may occur. In the foregoing embodiment, however, it is sufficient if the luminance values of the images PA and PB can be compared with each other, and the influence of deterioration in resolution caused by diffraction is very small. Particularly, by using a very small aperture stop, the influence of a drop in brightness of the edge of image field can be further eliminated, so that it is convenient.

An insufficient exposure amount due to stop-down of the aperture can be solved by, for example, decreasing the shutter speed in the CCD 303 or increasing the exposure time in the CCD 303. Concretely, it is sufficient to change also the image capturing condition regarding the shutter speed in step SP105. By the change, the range in which the pixel values after A/D conversion actually exist is enlarged, and the pixel values of a plurality of pixels in the image PB can be made values of a larger number of stages (steps). Thus, shading correction of higher precision can be realized. Since the noise component can be decreased, shading correction of further higher precision can be achieved. When the exposure time is increased, blurring may occur in an image. However, as it is sufficient to obtain the luminance ratio of the corresponding part in the images PA and PB, the blurring in an image is permitted to a degree that the images PA and PB can be aligned.

To compensate the insufficient exposure amount in the image PB, a countermeasure as described below can be further taken.

For example, by increasing the gain for adjusting the signal level in gain control performed by the analog signal processing circuit 121, the insufficient exposure amount can be compensated. Concretely, it is sufficient to set, as the gain of each pixel, a value larger than a normal set value (for example a value four times as large as the normal set value). After increasing the gain in the image capturing in step SP106, the reference image PB is obtained. In such a manner, the range in which the pixel values after AID conversion actually exist can be enlarged and the pixel values of a plurality of pixels in the image PB can be made values of a larger number of stages. Thus, shading correction of higher precision can be realized.

It is also possible to increase the amount of image data of each pixels as a value obtained by adding image signals of pixels around the pixel regarding the reference image PB. For example, it is sufficient to perform an image filtering process of converting the value of each of pixels in the image PB temporarily stored in the image memory 126 to a value obtained by adding the values of four pixels (or nine pixels) around the pixel. Alternately, signals of pixels around the pixel may be added to the image signal of the pixel by the analog signal processing circuit 121 at the stage of an analog signal outputted from the CCD 303. By the process, the pixel values of a plurality of pixels in the image PB can be made values of a larger number of stages. Thus, shading correction of higher precision can be realized.

Although the technique of capturing the image PB while reducing the focal length to 80% when the focal length is larger than the predetermined value and performing the shading correction of the method H1 has been described above, the present invention is not limited to the technique. Concretely, when the focal length cannot be reduced to 80% of the focal length at the time of capturing the image PA irrespective of existence of shading in the image PA, the focal length can be changed to a “dedicated focal length”, which is dedicated to the reference image PB.

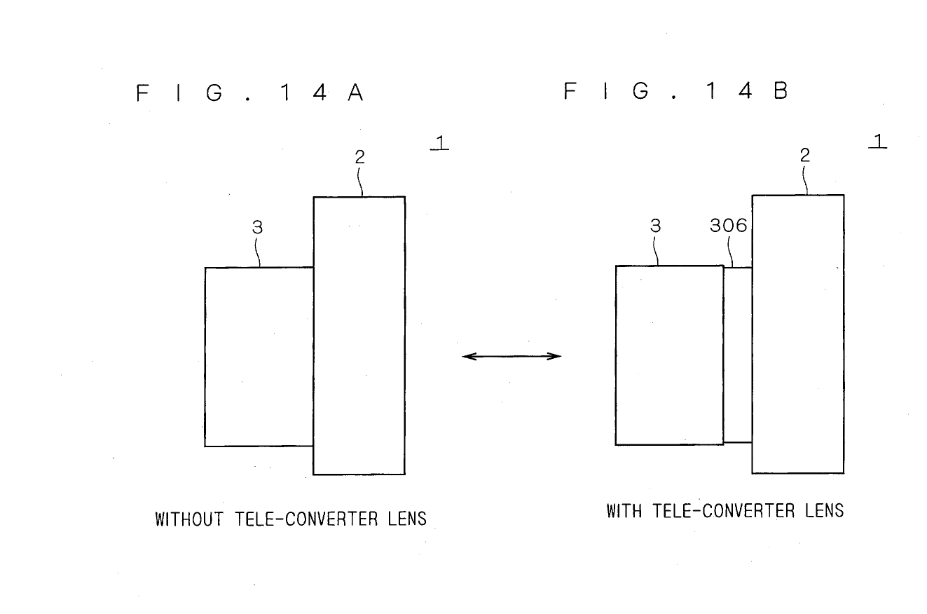

The “dedicated focal length”, dedicated to the reference image PB will now be described. Usually, a zoom lens changes its magnification by relative movement of the lens units. Due to mechanical constraints, the range of the focal length in which the focus position does not have to be changed is limited. Therefore, the range of the focal length used for normal image capturing operation (concretely, capturing of an image for appreciation) is limited. In other words, the focal length which can be set by the operator is limited to a predetermined range from the wide angle end to the telephoto end. The range is, for example in a zoom lens, from 28 mm (minimum focal length) to 200 mm (maximum focal length). FIG. 13 shows movement of the two lens units 300 and 301 for realizing each focal length in the two groups of zoom lens.

As shown in FIG. 13, by moving the two lens units mutually independent of each other, while changing the magnification in zooming from the telephoto end TE to the wide angle end WE, an image of the subject can be formed in the same position (concretely, an image forming surface of the CCD 303).

As shown in FIG. 13, in the case of moving the two lens units 300 and 301 from the telephoto end (TE) to the wide angle side and, further, moving them over the wide angle end (WE), one of the lens unit (300 in the diagram) can be further moved but the other lens unit (301 in the diagram) cannot be moved due to mechanical constraints. At this time, although the zoom state can be changed to the wider angle side (wider side) than the wide angle end, an out-of focus state is resulted. However, it is sufficient to obtain the ratio of luminance of the corresponding part in the images PA and PB, so that blurring of an image is permissible as long as the images PA and PB can be aligned.

The “dedicated focal length” can be realized, for example, by utilizing a collapsible region in a camera having a collapsible lens.

By moving each of the lens units 300 and 301 to the wide angle side, deterioration in resolution due to insufficient aberration correction may occur in the image PB. However, as long as the luminance values of the images PA and PB can be compared with each other, the influence of deterioration in resolution due to insufficient aberration correction is very small. Rather, by moving the lens units to the wide angle side, the influence of a drop in the brightness of the edge of image field can be eliminated, so that it is convenient.

As described above, as the image PB for shading correction, an image captured on the wider side than the wide angle end can be also employed. In other words, the focal length shorter than that of the wide angle end (in the example, focal length shorter than 28 mm (for example, 24 mm)) can be used as the focal length dedicated to capture the reference image PB. With the configuration, also in the case where the focal length is smaller than the predetermined value (for example, 28/0.8=35 mm) at the time of, for example, capturing an image at the wide angle end (with focal length=28 mm), by using the dedicated focal length (for example, 24 mm), the image PB of a wider angle of field can be captured. Therefore, by the operation similar to that in the case (ii), shading can be corrected.

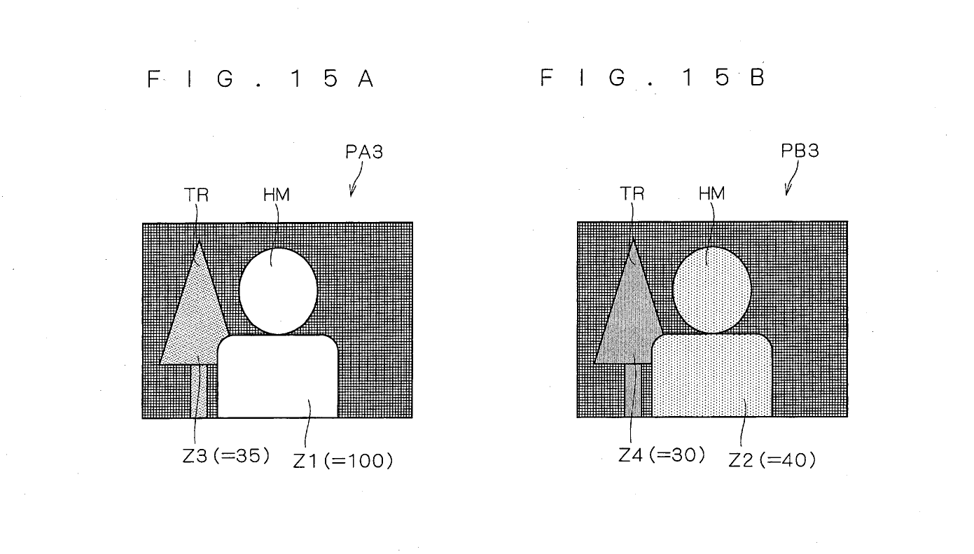

Further, as shown in the schematic side views of FIGS. 14A and 14B, a similar operation can be performed also in the case of capturing an image with a conversion lens (additional optical system) 306 attachable (detachable) to the digital camera 1. FIGS. 14A and 14B are schematic views showing the case where the conversion lens (to be specific, tele-conversion lens) is not attached and the case where the conversion lens is attached, respectively.

Specifically, in the case of attaching the tele-conversion lens for increasing the magnification as the conversion lens 306, an operation similar to the case (ii) can be performed. For example, it is sufficient to decrease the focal length to 80% and capture the image PB.

Alternately, in the case of attaching a wide conversion lens for capturing an image of a larger angle of field as the conversion lens 306, an operation similar to the modification can be performed. It is sufficient to capture the image PB with, for example, a focal length (such as 24 mm) dedicated to capturing of the image PB.

Whether the conversion lens is attached or not may be identified according to input information entered by the operator to the digital camera 1 by using a predetermined menu screen. Alternately, in the case where the conversion lens having an electric contact is attached, attachment of the conversion lens can be recognized on the basis of an attachment signal inputted to the overall control unit 150 of the digital camera 1 via the electric contact on the conversion lens 306 side and the electric contact on the side of the body of the digital camera 1.

Various conversion lenses can be attached to the digital camera 1. By the operation as described above, shading can be corrected according to a conversion lens attached to the digital camera 1.

B. Second Embodiment

B1. Outline and Principle

In a second embodiment, the technique (2) of correcting the shading P2 that the illuminance of the subject becomes nonuniform due to an illumination light source (such as electronic flash light) will be described. The shading P2 generats due to insufficiency or excessiveness of illuminance of the subject based on variations in the distance of subjects in an image. The correcting method to be described later will be referred to as, for convenience, the shading correction of the method H2. A digital camera according to the second embodiment has the configuration similar to that of the digital camera of the first embodiment, so that the different points will be mainly described later.

FIGS. 15A and 15B illustrate the shading P2 and correction of the shading P2. FIGS. 15A and 15B show images PA (PA3) and PB (PB3), respectively, of the same subjects with and without electronic flash light. The images PA3 and PB3 are images of the same subjects. In each of the images PA and PB, a human HM existing in the closest position and a tree TR behind the human HM are captured as subjects. FIG. 15A shows the image PA3 captured with electronic flash light, and FIG. 15B shows the image PB3 captured without electronic flash light. Since the image capturing condition of illumination (more specifically, the presence or absence of electronic flash light) of the image PA3 and that of the image PB3 are different from each other, the shading states are different from each other.

The illumination effect of electronic flash light on a subject varies according to the distance from the digital camera 1 to the subject (that is, subject distance). More specifically, the illumination effect produced by electronic flash light is inversely proportional to the square of the distance. For example, in FIGS. 15A and 15B, in the case where the distance from the digital camera 1 to the human HM is set to 1 and the distance from the digital camera 1 to the tree TR is set to 3, if the illumination effect on the human HM by the electronic flash light is 1, the illumination effect on the tree TR by the electronic flash light is 1/9. Therefore, in the image PA3, an image of the tree TR having a longer subject distance which is darker than its actual looks is captured. As described above, in the image PA3, the shading P2, which is caused by excessiveness or insufficiency of subject illumination based on variations in the subject distance according to the subjects in the image, is generated.

The shading P2 can be corrected by multiplying an increased amount of luminance by the electronic flash light by the value of the square of the relative distance to the subject. For example, in the above example, by multiplying the increase amount of the luminance of the tree by the electronic flash light by nine times, variations in the illumination effect caused by variations in the distance can be corrected.

However, if the luminance is corrected too much on the far subject, a noise component is amplified and the picture quality may deteriorate. To avoid such a situation, it is preferable to provide the upper limit for the correction factor. In other words, in the case where the correction factor calculated as described above is larger than a predetermined upper limit value (for example, about 4), it is preferable to change the correction factor to the predetermined upper limit value.

B2. Operation

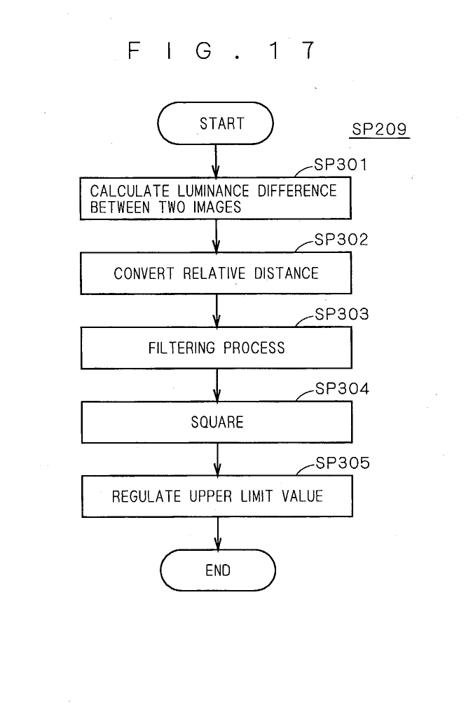

Referring to FIGS. 16 and 17, the detailed operation in the second embodiment will now be described. FIG. 16 is a flowchart showing an example of the image capturing operation and FIG. 17 is a flowchart more specifically showing a part (step SP209) of the operation.

In the following operation, the reference image PB is captured earlier than the object image PA. This is because of the precondition that the shading correction of the method H2 is always made. In the second embodiment, a live view image (moving image for determining framing of the subject before image capturing) captured by the digital camera 1 is used as the reference image PB. More specifically, an image captured immediately before the shutter start button 9 enters the full depression state S2 among a plurality of images continuously captured every predetermined cycle (for example, 1/30 second) for live view is obtained as an image PB (PB3). It can prevent a deviation between the timing of depressing the shutter start button 9 and the timing of capturing the object image PA.

First, as shown in FIG. 16, in steps SP201 to SP203, the reference image PB3 is obtained. As described above, in the image capturing standby state, image capturing conditions such as aperture and zoom are set (step SP201), an image for live view is captured every 1/30 (second) by the CCD 303 (step SP202), and temporarily stored in the image memory 126 (step SP203). The operation is repeatedly performed until it is determined in step SP204 that the shutter start button 9 enters the full depression state S2. An image for live view captured immediately before the shutter start button 9 enters the full depression state S2 is captured as the final reference image PB3.

When the shutter start button 9 is depressed to the full depression state S2, the object image PA (PA3) of the subject is captured (step SP205) and stored in the image memory 126 (step SP206).

After that, in step SP207, the images PA and PB are aligned. For the alignment, various techniques such as pattern matching can be used. By the alignment, the same parts of the subject in the images PA and PB are associated with each other. Also in the case where the pixel sizes of the images PA and PB are different from each other, each of the pixels in the image PB is associated with any of the pixels in the image PA by the alignment.

In step SP208, the branching process is performed according to a result of the alignment. If the alignment fails, without performing the shading correction of the method H2, the program advances to step SP211. On the other hand, if the alignment succeeds, the program advances to step SP209 and the shading correction of the method H2 is carried out.

In step SP209, as described above, by using the two images PA and PB, the correction table is generated. Concretely, a correction factor h3 on a pixel unit is obtained as follows. The correction factor h3 may be computed not necessarily on the pixel unit basis but also on the unit basis of a block having a predetermined size.

Step SP209 will be described with reference to FIG. 17.

First, the luminance difference between the two images PA and PB is calculated on the pixel unit basis (step SP301) and the relative distance of the subject in each pixel position is obtained on the basis of the luminance difference (step SP302).

The relative distance between the subjects, or the difference between the distances of subjects can be calculated on the basis of the two images PA3 and PB3. In the following, the process of calculating the relative distance will be described. As also shown in FIGS. 15A and 15B, the case where the luminance Z2 of a human portion is 40 and the luminance Z4 of the tree portion is 30 in the image PB3, and where the luminance Z1 of the human portion is 100 and the luminance Z3 of the tree portion is 35 in the image PA3 is assumed. It is also assumed that the human portion of the image PA3 is properly exposed and the subject distance of the human is used as a reference distance. The present invention is not limited to the case but the reference distance may be determined by using a subject determined as a main subject at the time of auto focusing out of a plurality of subjects.

With such a procedure, the relative distance of the tree portion is obtained. First, the difference between the pixel values of the images PA3 and PB3 regarding the tree portion (Z3−Z4=35−30) is calculated and the ratio of the differential values with respect to the pixel value of the image PB is obtained (=(Z3−Z4)/Z4=(35−30)/30=⅙). The ratio corresponds to the rate of increase of the tree portion by the electronic flash light. Similarly, regarding the human portion as reference, the ratio of the differential value to the pixel value in the image PB3 is obtained (=(Z1−Z2)/Z2=(100−40)/40=3/2). The ratio corresponds to the rate of increase of the human portion by the electronic flash light.

Consequently, when the illumination effect of electronic flash in the tree portion is normalized by using the human portion as a reference, (Z3−Z4)/Z4×(Z2/(Z1−Z2))=(⅙)×(⅔)=1/9. Therefore, the relative distance of the tree portion when the subject distance of the human portion is used as a reference distance is the square root of the inverse of 1/9, that is, 3. In such a manner, the relative distance of the subject corresponding to each of the pixels can be calculated.

After that, a predetermined filtering process is performed to reduce variations in the value due to noise or movement of the subject (step SP303). The filtering process may be performed by using a predetermined filter circuit in the image processing circuit 124.

In step SP304, a value as a square value of the relative distance is obtained as the correction factor h3. In step SP305, the upper limit value of the correction factor is regulated. Specifically, when the correction factor h3 calculated in step SP304 becomes larger than a predetermined upper limit value (for example, about 4), the correction factor h3 is changed to the predetermined upper limit value.

In such a manner, the correction factor h3 can be computed. Such a correction factor h3 is obtained every pixel and stored in the correction table. The correction table is a table in which a square value of the ratio of the subject distance in each pixel position relative to the reference distance (that is, relative distance) is stored every pixel. Although the subject distance is obtained as a value normalized by using the reference distance, the present invention is not limited to the value. For example, the subject distance may be also computed as a value indicative of an actual distance without being normalized on the basis of a measured distance value obtained at the time of autofocusing.

In step SP210 (FIG. 16), on the basis of the correction table in which the correction factor h3 is stored, shading correction is performed on the image PA. That is, the pixel value of each pixel is changed to a value obtained by amplifying an increase amount (change amount) by the electronic flash light with the correction factor h3. Concretely, the pixel value is changed by using the following equation 3.

Zc=Za−(Za−Zb)+h3(Za−Zb)=Za+(h3−1)(Za−Zb) Equation 3

Provided that Za denotes a pixel value of each of pixels in the object image PA, Zb denotes a pixel value of a corresponding pixel in the reference image PB, and Zc indicates a pixel value after change.

Consequently, when the correction factor h3 is larger than 1, a new pixel value Zc is larger than the original pixel value Za, and the insufficient illuminance amount is corrected (or compensated). When the correction factor h3 is smaller than 1, a new pixel value Zc is smaller than the original pixel value Za and an excessive illuminance amount is corrected. When the correction factor h3 is 1, the original pixel value Za becomes a new pixel value Zc. Such a correction computing process is performed by the shading correction circuit 123 under control of the overall control unit 150.

After that, in step SP211, further, predetermined image processes (such as WB process, pixel interpolating process, color correcting process, and γ correction process) are performed on the image PA subjected to shading correction and, the processed image PA is temporarily stored in the image memory 126. Subsequently, the image PA stored in the image memory 126 is transferred to the memory card 8 and stored in the memory card 8 (step SP212).

In such a manner, the operation of capturing the image PA with shading correction is performed.

According to the second embodiment, as described above, by using the two images PA and PB whose shading states are different from each other, the influence of shading in the image PA finally obtained can be lessened. Unlike the conventional technique, it is unnecessary to accompany the operation of manually attaching/detaching a white cap, so that shading correction can be made with simple operation.

Although the case of capturing two images while changing the presence/absence of electronic flash light and performing the shading correction on the image captured with electronic flash light has been described above in the second embodiment, the present invention is not limited to the case. For example, other two images can be captured while changing the presence and absence of light emission of an illumination light source (such as a video light) other then electronic flash. Not only the state where the illumination light source such as video light does not completely emit light but also the state where very weak light with which the subject is not substantially illuminated can be regarded as a state where there is no light emission from the illumination light source. These states can be used for capturing a reference image.

In the second embodiment, an image for live view is captured as the reference image PB. Various parameters in automatic exposure (AE) control and various parameters in white balance control can be obtained by using the reference image PB as an image for live view. Therefore, both of the various parameters in the AE control or WB control and the parameters in the shading correction can be obtained on the basis of the same reference image PB. That is, the number of images to be captured can be minimized.

C. Others

Although the case of correcting pixel data in each block by using only correction data corresponding to the block has been described in the foregoing embodiments, the present invention is not limited to the case. For example, correction data on the block unit basis is set as a reference value of each block, the reference values of a block B0 to which the target pixel belongs and a peripheral block B1 are weighted on the basis of the relation among the center positions of the neighboring blocks B0 and B1 and the position of the object pixel, and the correction factor of each pixel may be calculated. Thus, while suppressing the data size of the correction table, shading correction of the larger number of stages can be performed.

In the foregoing embodiments, the case of making the shading correction by using the shading correction factor has been described. The present invention is not limited to the case but the shading correction may be made by using other shading correction information. For example, the pixel value of each pixel is not multiplied with the shading correction factor of each pixel, but shading correction may be performed according to a predetermined formula using the position of each pixel as a variable. In this case, it is sufficient to obtain the value of each coefficient parameter in the formula by comparing the two images PA and PB.

In each of the foregoing embodiments, the A/D conversion is performed and, then, shading correction is made. After that, the other digital image signal processes (such as the WB process, pixel interpolating process, color correcting process, and γ correcting process) are performed. The present invention is not limited to the foregoing embodiments. For example, it is also possible to perform some of the plurality of digital signal processes, shading correction and, after that, to perform the remaining digital signal processes.

The present invention may be embodied by either a computer system controlled in accordance with software programs or a hardware system having individual hardware elements for conducting the respective steps as described in the preferred embodiments. Both of the software elements and the hardware elements are included in the terminology of “devices” which are elements of the system according to the present invention.

What is claimed is:

1. A digital camera comprising:
an image pickup device for capturing two images whose shading states of the same subject are different from each other by changing an image capturing condition of at least one of an imaging optical system and an illumination system; and
a correction information calculator for obtaining shading correction information for one of said two images on the basis of said two images.

2. The digital camera according to claim 1, wherein
said two images are first and second images captured while changing an image capturing condition regarding an aperture of said imaging optical system, and
said second image is captured in a state where said aperture is further stopped down as compared with the case of capturing said first image.

3. The digital camera according to claim 2, further comprising:
a shutter speed changer for making shutter speed in said image pickup device at the time of capturing said second image slower than that at the time of capturing said first image.

4. The digital camera according to claim 2, further comprising:
a gain controller for increasing a gain for adjusting a level of a signal from said image pickup device to be larger at the time of capturing said second image as compared with that at the time of capturing said first image.

5. The digital camera according to claim 2, further comprising:
an adder device for adding a signal of a peripheral pixel of a particular pixel to a signal of the particular pixel in said image pickup device at the time of capturing said second image.

6. The digital camera according to claim 1, wherein
said two images are a first image and a second image captured while changing an image capturing condition regarding a focal length of said imaging optical system,
said second image is captured with said focal length shorter than that at the time of capturing said first image, and
said correction information calculator obtains said shading correction information by using information of an image region corresponding to a range of said first image in said second image.

7. The digital camera according to claim 6, wherein
said imaging optical system includes a conversion lens which can be attached/detached to/from said digital camera.

8. The digital camera according to claim 6, wherein
said second image is captured with a focal length shorter than a minimum focal length which can be set by the operator.

9. The digital camera according to claim 1, wherein
when a difference between a first luminance ratio as a luminance ratio between corresponding regions of said two images with respect to a particular part of said one of images and a second luminance ratio as a luminance ratio between corresponding regions of said two images with respect to a peripheral part of said particular part is smaller than a predetermined degree, said correction information calculator obtains shading correction information of the particular part by using a first rule based on the luminance of the corresponding regions in said two images with respect to said particular part, and
when said difference is larger than said predetermined degree, said correction information calculator obtains shading correction information of the particular part by using a second rule different from said first rule.

10. The digital camera according to claim 9, wherein
said second rule is a rule for obtaining shading correction information of the particular part on the basis of the luminance of the corresponding regions in said two images with respect to said peripheral part.

11. A digital camera comprising:
an image pickup device for capturing two images of the same subject with and without electronic flash light, respectively; and
a correction information calculator for obtaining shading correction information on the image captured with electronic flash light in said two images on the basis of said two images.

12. The digital camera according to claim 11, wherein
said correction information calculator obtains shading correction information on the basis of a luminance difference of each of the corresponding regions in said two images.

13. The digital camera according to claim 12, wherein
said correction information calculator calculates a subject distance in each of said corresponding regions on the basis of a luminance difference of each of the corresponding regions in said two images.

14. The digital camera according to claim 13, wherein
said correction information calculator obtains a value proportional to the square of the subject distance in each of said corresponding regions as a shading correction factor in each of said corresponding regions, said shading correction factor representing said correction information.

15. The digital camera according to claim 14, wherein
an upper limit value is provided for said shading correction factor.
